(19) United States
(12) Patent Application Publication
(10) Pub. No.: US 2014/0372102 A1
(43) Pub. Date: Dec. 18, 2014

(54) COMBINING TEMPORAL PROCESSING AND TEXTUAL ENTAILMENT TO DETECT TEMPORALLY ANCHORED EVENTS

(71) Applicant: Xerox Corporation, Norwalk, CT (US)

(72) Inventors: Caroline Hagege, Grenoble (FR); Guillaume Jacquet, Ispra (IT)

(21) Appl. No.: 13/920,462

(22) Filed: Jun. 18, 2013

(51) Int. Cl. G06F 17/28

(52) U.S. Cl. CPC G06F 17/28
USPC 704/9

(57) ABSTRACT

A method for extraction of events includes performing linguistic processing on a collection of text documents to identify predicates and respective arguments of the predicates and performing temporal processing on the collection of documents to normalize referential dates. A query is received which includes a topic and date information which defines a date range. A collection of excerpts from the collection of documents is identified, each excerpt including an argument which is based on the topic and a normalized reference to a date which matches the defined date range. A plurality of sets of events in the collection of excerpts is identified, each set of events including a plurality of the excerpts in the collection that are linked together by entailment relationships.

### BACKGROUND

The exemplary embodiment relates to the identifications of groups of related events in a corpus of documents and finds particular application in identifying news articles that relate to the same event.

Many strategic activities such as decision making or technology forecasting benefit from information extraction from news articles. A vast quantity of news articles are now created daily and it is difficult and time consuming to sift through the information manually to identify articles relating to a common event or sequence of events that are relevant to the information being sought. Additionally, there often a considerable amount of redundancy in the articles. For example, all or a portion of one article may be repeated in another article generated later by a different news source.

The most common approaches for the task of event detection use clustering techniques. In this case, all the articles containing similar content (i.e., similar words) are aggregated into one cluster which could correspond to an event. There are problems, however, in using clustering techniques. One is that two articles determined to be similar, given the words that they contain, can refer to two different events. For example, an event can recur multiple times. Different articles referring to such a recurrent event but not necessarily referring to the same occurrence of this recurrent event are readily found. This is the case in the news articles 1 and 2 which refer to different earthquakes that successively struck Sumatra in 2007.

News article 1 (Mar. 6, 2007): An earthquake struck the Indonesian island of Sumatra last Tuesday

News article 2 (Sep. 12, 2007): An earthquake struck the Indonesian island of Sumatra last Tuesday

Based on the document creation time, the first event occurred on Mar. 6, 2007, while the second event occurred on Sep. 12, 2007.

Other cases, based on the word similarity, are very close but do not refer to the same event (see news articles 3 and 4 below). Another problem is that two articles may have no common words but still refer to the same event (see news articles 3 and 5, below).

News article 3 (Feb. 2, 2012): Obama met Hollande during the UN conference

News article 4 (Feb. 2, 2012): Obama met Merkel during the UN conference

News article 5 (Feb. 2, 2012): US and French presidents gave a common interview at the NYC United Nations

There remains a need for a system and method for event extraction that are able to identify relevant events and also to aggregate references to them when the same relevant event is mentioned multiple times in different text sources.

### INCORPORATION BY REFERENCE

The following references, the disclosures of which are incorporated herein in their entireties by reference, relate generally to clustering of items: U.S. Pub. No. 20120030163, published Feb. 2, 2012, entitled SOLUTION RECOMMENDATION BASED ON INCOMPLETE DATA SETS, by Ming Zhong, et al.; U.S. Pub. No. 20110137898, published Jun. 9, 2011, entitled UNSTRUCTURED DOCUMENT CLASSIFICATION, by Albert Gordo, et al.; U.S. Pub. No. 20100191743, published Jul. 29, 2010, entitled CONTEXTUAL SIMILARITY MEASURES FOR OBJECTS AND RETRIEVAL, CLASSIFICATION, AND CLUSTERING USING SAME, by Florent C. Perronnin, et al.; U.S. Pub. No. 20080249999, published Oct. 9, 2008, entitled INTERACTIVE CLEANING FOR AUTOMATIC DOCUMENT CLUSTERING AND CATEGORIZATION; U.S. Pub. No. 20070239745, published Oct. 11, 2007, entitled HIERARCHICAL CLUSTERING WITH REAL-TIME UPDATING, by Agnes Guerraz, et al.; U.S. Pub. No. 20070143101, published Jun. 21, 2007, entitled CLASS DESCRIPTION GENERATION FOR CLUSTERING AND CATEGORIZATION by Cyril Goutte; and U.S. Pub. No. 20030101187, published May 29, 2003, entitled METHODS, SYSTEMS, AND ARTICLES OF MANUFACTURE FOR SOFT HIERARCHICAL CLUSTERING OF CO-OCCURRING OBJECTS, by Eric Gaussier, et al.; and U.S. application Ser. No. 13/437,079, filed Apr. 2, 2012, entitled FULL AND SEMI-BATCH CLUSTERING, by Matthias Galle, et al.

### BRIEF DESCRIPTION

In accordance with one aspect of the exemplary embodiment, a method for extraction of events includes performing linguistic processing on a collection of text documents to identify predicates and respective arguments of the predicates and performing temporal processing on the collection of documents to normalize referential dates. A query is received which includes a topic and date information which defines a date range. A collection of excerpts from the collection of documents is identified, each excerpt including an argument which is based on the topic and a normalized reference to a date which matches the defined date range. A plurality of sets of events in the collection of excerpts is identified, each set of events including a plurality of the text excerpts in the collection that are linked together by entailment relationships. At least one of the performing linguistic processing, performing temporal processing, identifying a collection of excerpts, and performing textual entailment may be performed with a computer processor.

In accordance with another aspect of the exemplary embodiment, a system for extraction of events includes memory which stores an annotated collection of natural language text documents in which predicates and respective arguments of the predicates are identified, at least one of the arguments of each identified predicate including a temporal expression which is normalized with respect to a reference date of a respective document. A filtering component, based on an input query which includes a topic and date information which defines a date range, identifies a collection of excerpts from the annotated collection of documents, each excerpt including an argument, which is based on the topic, and a normalized reference to a date which matches the defined date range of the query. A textual entailment component identifies excerpts in the collection that are linked together by entailment relationships. An event set identification component identifies a plurality of sets of events in the collection of excerpts, each set of events comprising a plurality of the excerpts in the collection that are linked together by entailment relationships. A processor implements the components.

In accordance with another aspect of the exemplary embodiment, a method for generating a chronology includes receiving a collection of news articles each article identifying a reference date and receiving a query which includes a topic and date information which defines a date range. The articles are natural language processed to identify excerpts, each of the excerpts including a predicate and arguments of the predicate, a first of the arguments of the predicate matching at least part of the topic, a second of the arguments of the predicate including a temporal expression which, when normalized with respect to the reference date of the article, matches the date information of the query. The excerpts are partitioned into sets of events, each set of events including excerpts that are linked together by entailment relationships. For each of a plurality of the sets of events, a main event is identified that is based on an excerpt which does not entail any of the other excerpts in the respective set. A chronology is formed, based on the main events. At least one of the processing of the articles, partitioning, identifying main events, and forming a chronology may be performed with a computer processor.

### BRIEF DESCRIPTION OF THE DRAWINGS

FIG. 1 is an overview of an exemplary system and method for extraction of events;

FIG. 2 illustrates a system for extraction of events in accordance with one aspect of the exemplary embodiment;

FIG. 3 illustrates a method for extraction of events in accordance with another aspect of the exemplary embodiment; and

FIG. 4 illustrates part of the method for extraction of events of FIG. 3, in accordance with one embodiment.

### DETAILED DESCRIPTION

The exemplary system and method provide for automatically extracting events and relations between events from a large corpus of documents, such as news articles. The method uses natural language processing (NLP) techniques, including textual entailment and temporal processing, in order to address the problems often found in conventional clustering methods. The combination of these techniques provides an efficient way to detect and aggregate similar events from multiple text sources. It finds particular application in the case of news articles, where there is a great deal of redundancy (common information) among news articles.

Temporal Processing enables a fine grained and normalized temporal coordinate to be attached to a text excerpt. This allows multiple events that happened on the same date to be identified, even if the corresponding text excerpts do not have any common words. At the same time it avoids the merging of two similar text excerpts that did not happen at the same time, even if the two text excerpts share several common words.

Textual Entailment (TE) enables grouping together text excerpts that are expected to refer to a same event based on word similarity and semantic similarity instead of only on word similarity. Additionally, TE provides non-symmetric relations between text excerpts. As a result, a kind of generality ordering is established between the related textual contents. This ordering can be then further exploited. In particular, textual entailment offers a way to select from a set of related events the one that is the most appropriate to represent the set.

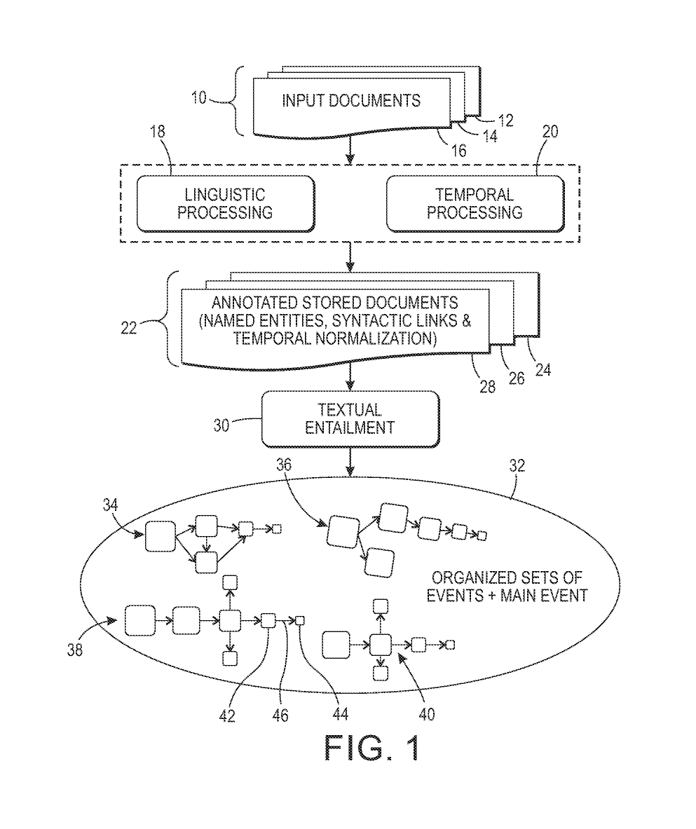

With reference to FIG. 1, an overview of the exemplary system and method is shown. The system and method automatically extract events and relations between events from a large collection of documents, such as a collection of news articles.

The system takes as input a collection 10 of documents 12, 14, 16, etc. The documents are processed by a linguistic processing component 18 and a temporal processing component 20 to generate a collection 22 of annotated text excerpts 24, 26, 28, etc. of the documents, in which text elements (such as named entities) and syntactic dependencies that involve them have been identified, and temporal expressions have been normalized. As a result, a set of events is detected. Each event corresponds to a predicate (either verbs or nouns) together with its arguments. The predicates are attached to a normalized temporal coordinate, when this is possible.

Given a query, a subset of responsive text excerpts is identified. Each responsive text excerpt includes a temporal expression that, when normalized, includes a date which matches (i.e., falls within) the date range of the query and a text element that is responsive to the topic part of the query. The text element may be or include a named entity, although other types of text elements are also contemplated, such as common nouns, verbs, and the like. Both the temporal expression and the text element are arguments of (i.e., are in a syntactic or semantic dependency relationship with) the same predicate.

A textual entailment component 30 identifies pairs of text excerpts (“events”) in the remaining collection 32 that entail each other, allowing entailing excerpts (and the documents 12, 14, 16 that contain them) to be grouped into event sets (clusters) 34, 36, 38, 40, etc., each event set including a plurality of text excerpts that are considered as events 42, 44, etc. The events are linked by entailment relationships, indicated by one way arrows 46 from the entailing to the entailed event, although in some cases, two text excerpts (events) may entail each other. In this case, the two text excerpts are considered to be equivalent. The events in a set can form chains of three or more events, each event in the chain entailing the next one at the tip of the arrow. In each group, one of the events may be designated as a main event, such as event 44. Each main event is indicated in FIG. 1 by the smallest block in the respective set.

Components 18, 20, 30 illustrated in FIG. 1 may be embodied as hardware or a combination of software and hardware.

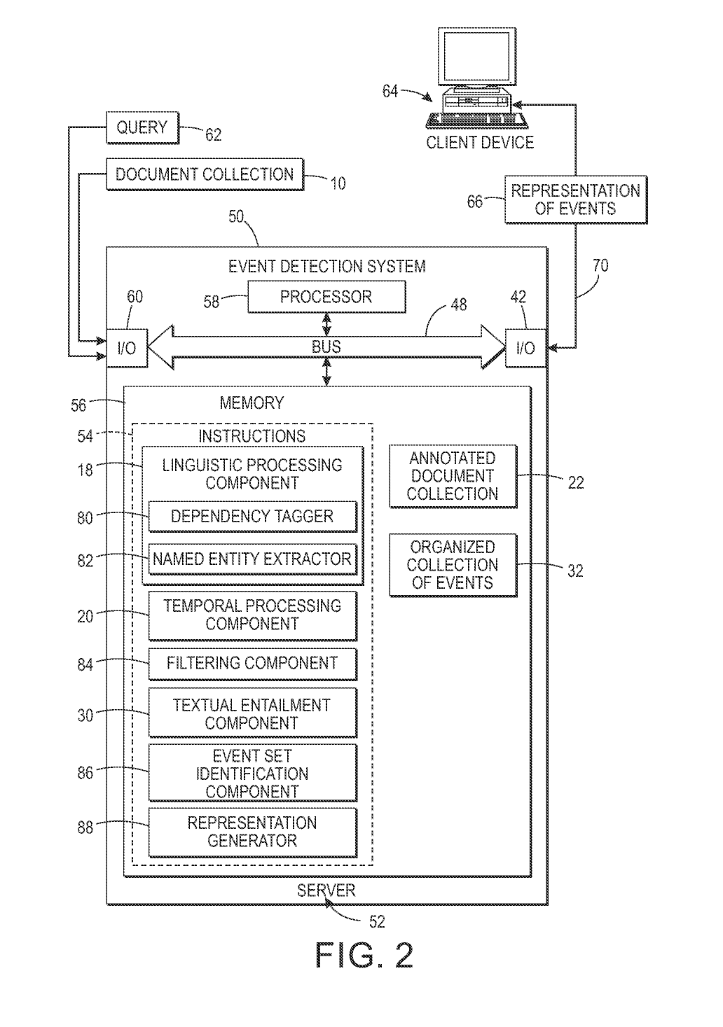

FIG. 2 illustrates an exemplary event detection system 50 in which the components 18, 20, 30 may be implemented.

The system 50 may be hosted by one or more computing devices 52, such as a specific or general purpose computing device, for example, as desk top, laptop, tablet, or server computer, a smartphone, or the like. Instructions 54, for performing the exemplary method are stored in memory 56 of the computing device. The computing device includes a processor 58, in communication with the memory 56, for executing the instructions. A network interface 60 receives the document collection 10 as input, e.g., from a web server, and stores it in local memory 56, or remote memory, during processing. Interface 60 also receives a query 62, e.g., from an associated client device 64. A representation 66 of the events identified by the system may be output to the client device or to another memory storage device via an input/output interface 68 that is linked to the client device by a wired or wireless link 70, such as a local area network or a wide area network, such as the Internet. A data/control bus 72 links the hardware components 56, 58, 60, 68 of the computing device.

The linguistic processing component 18 handles the analysis of the input text and may include a dependency tagger 80 and a named entity extractor 82. The temporal processing component calculates temporal stamps that are attached to the events mentioned in the text. Some or all of these components may be combined into a linguistic parser. A filtering component 84 filters processed documents based on the input query 62 and the document annotations provided by the linguistic processing component 18 and temporal processing component 68.

An event set identification component 86 generates organized sets of events in the collection 32, based on the entailment relationships identified by the entailment component 30.

A representation generator 88 generates a representation 66 of the sets of events for display to a user on the client device.

As will be appreciated, the linguistic and temporal processing of the collection of documents may be performed by a separate system which outputs an annotated document collection based thereon. In that case, the linguistic and temporal processing components 18, 20 of the system 50 may be omitted.

The memory 56 may represent any type of non-transitory computer readable medium such as random access memory (RAM), read only memory (ROM), magnetic disk or tape, optical disk, flash memory, or holographic memory. In one embodiment, the memory 56 comprises a combination of random access memory and read only memory. In some embodiments, the processor 58 and memory 56 may be combined in a single chip. The network interface 60 and/or 62 allows the computer to communicate with other devices via a computer network, such as a local area network (LAN) or wide area network (WAN), or the Internet, and may comprise a modulator/demodulator (MODEM) a router, a cable, and/or Ethernet port.

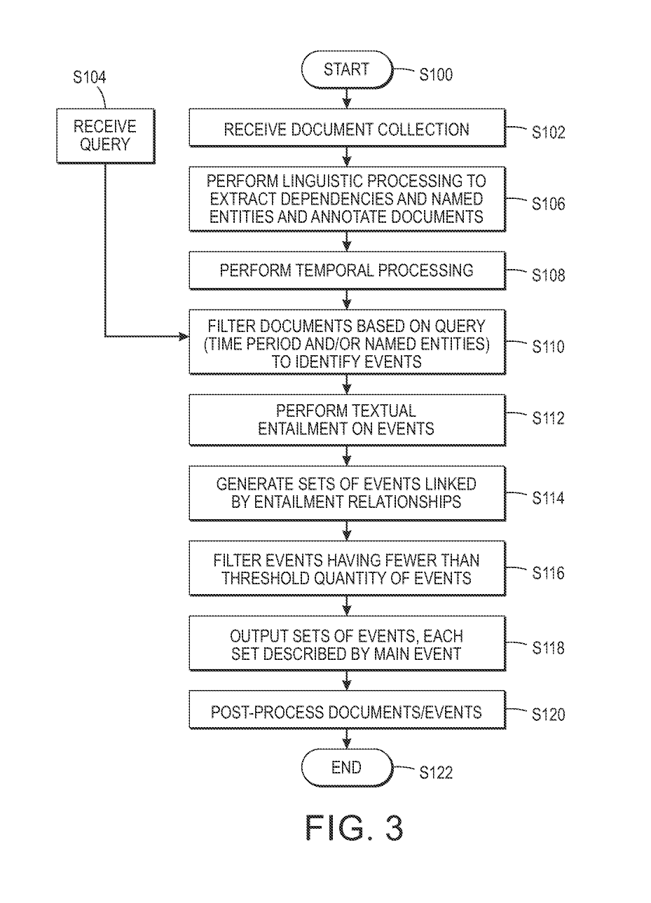

The digital processor 58 can be variously embodied, such as by a single-core processor, a dual-core processor (or more generally by a multiple-core processor), a digital processor and cooperating math coprocessor, a digital controller, or the like. The digital processor 58, in addition to controlling the operation of the computer 52, executes instructions stored in memory 56 for performing the method outlined in FIGS. 3 and/or 4.

The term “software,” as used herein, is intended to encompass any collection or set of instructions executable by a computer or other digital system so as to configure the computer or other digital system to perform the task that is the intent of the software. The term “software” as used herein is intended to encompass such instructions stored in storage medium such as RAM, a hard disk, optical disk, or so forth, and is also intended to encompass so-called “firmware” that is software stored on a ROM or so forth. Such software may be organized in various ways, and may include software components organized as libraries, Internet-based programs stored on a remote server or so forth, source code, interpretive code, object code, directly executable code, and so forth. It is contemplated that the software may invoke system-level code or calls to other software residing on a server or other location to perform certain functions.

As will be appreciated, FIG. 2 is a high level functional block diagram of only a portion of the components which are incorporated into a computer system 30. Since the configuration and operation of programmable computers are well known, they will not be described further.

FIG. 3 illustrates a method for extraction of events which can be performed with the system of FIG. 2. The method begins at S100.

At S102, a document collection, such as a collection of news articles, is received into memory, such as local or remote memory.

At S104 a query is received. This step may occur later in the method. The query may identify a date range and a topic.

At S106, linguistic processing is performed on the text of the documents to extract dependencies between predicates and their arguments, and to identify any named entities. The documents are annotated based on the processing.

At S108, temporal processing is performed on the documents to extract referential dates (references to dates) and normalize them. In this step, referential dates are anchored to the date to which they refer.

At S110 the documents may be filtered based on the query (date range and topic) to identify a set of relevant text excerpts (“events”).

At S112 textual entailment is performed on the filtered text excerpts to identify entailment relations.

At S114 event sets are generated, each comprising a group of events that are linked by entailment relationships.

At S116 event sets containing fewer than a threshold quantity of events may be filtered out.

At S118, sets of events may be output, each set described by a main event.

At S120 a further process may be performed on the documents, such as generating a chronology of events related to the query. The method ends at S122.

Further details of the system and method will now be described.

### The Document Collection 10

A “document,” as used herein, generally refers to a body of text and may be a subpart of a larger document which may also include other information, such as drawings, photographs, and the like. Each document may include one or more text strings expressed in a same natural language having a vocabulary and a grammar, such as English. Each text string can be as short as a phrase or clause of a sentence and generally comprises a sentence and may comprise two or more contiguous sentences. In the exemplary embodiment, the text strings considered are generally each one sentence in length.

In the case of news articles, the documents are generally short, such as one or a few paragraphs. In the case of longer documents, such as scientific papers, a part of the document may be taken as representative of the document, such as the abstract or summary.

Each input document 12, 14, 16, etc., generally includes a plurality of text strings, such as sentences, each comprising a plurality of text elements, such as words, phrases, numbers, and dates, or combinations thereof. In the case of input XML documents, the searchable text strings may include hidden text.

The computer system transforms the input text into a body of annotated, searchable text, here illustrated as annotated documents 24, 26, 28. In particular the output text is annotated with tags, such as XML tags, metadata, or direct annotations, identifying named entities and dependencies that involve them. As will be appreciated, a variety of other annotations may also be applied to the document.

The input documents 10 may be received in any suitable form, such as in text format or in image format. In the case of images, the documents may be OCR processed to generate text. The documents in the collection may be received in a single batch or in multiply batches, e.g., as they are output by a news service. Accordingly, they can be processed at the same time or singly as they arrive. The documents may relate to a number of different topics or to a common topic.

### The Query

The query can be a natural language query which is processed by the system to identify a date range and a topic. In another embodiment the query is input in a format in which the topic and date range are specified. For example a user interface allows a user to enter a date range in a date information field and a topic in a topic field. The date range may be a single calendar day, or other date range, e.g., spanning minutes, hours, several days, weeks, months or years. The date range may be selected by inputting start and end dates or the date range may be otherwise computed from the date information input. For example, if the user inputs “2007” in the date information field, the system recognizes Jan. 1, 2007-Dec. 31, 2007 as the date range. The topic may be a word or a phrase, or a collection of words and may be supplemented, by the user or by the system, with synonyms that are to be recognized as equivalents. The topic may be, or may include, a named entity, such as “Haiti” in the example below.

### Natural Language Processing

The natural language processing of the documents is performed with the linguistic processing component 18, such as a fine grained linguistic parser, the temporal processing component 20, and the textual entailment component 30.

### Linguistic Processing

During parsing of the document, the parser annotates the text strings of the document with tags (labels) which correspond to grammar rules, such as lexical rules, syntactic rules, and dependency (semantic) rules. The lexical rules define relationships between words by the order in which they may occur or the spaces between them. Syntactic rules describe the grammatical relationships between the words, such as noun-verb, adjective-noun. Semantic rules include rules for extracting dependencies (subject-verb relationships, object-verb relationships, etc.), and co-reference links. The application of the rules may proceed incrementally, with the option to return to an earlier rule when further information is acquired.

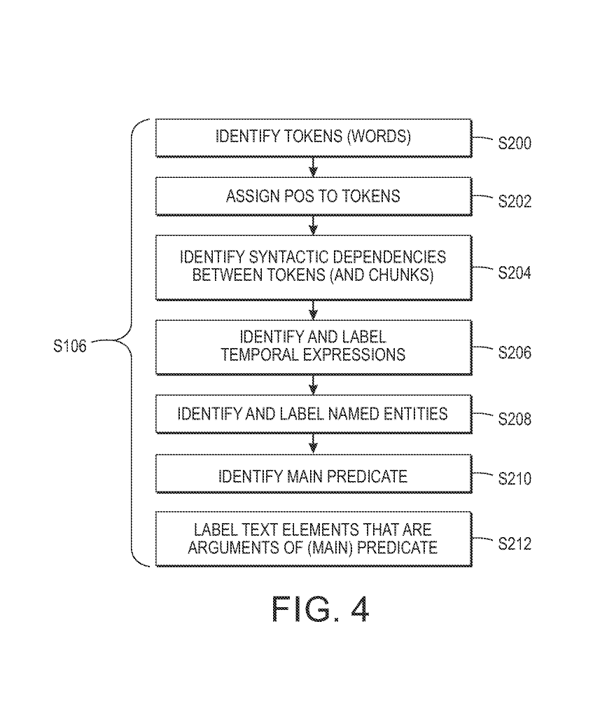

In the exemplary embodiment, the dependency analysis includes, for each text string, identifying which is/are the predicates, including the main predicate, and what are the arguments attached to these predicates. For example, S106 includes the substeps illustrated in FIG. 4. The natural language parser 18 treats each sentence as a sequence of tokens such as words and punctuation. At S200, each sentence is broken down into a sequence of tokens by the parser. At S202, morphological information is associated with each token, such as a part of speech, selected from a predefined set of part of speech tags. At S204, dependencies between tokens or groups of tokens (chunks) are identified. At S206, temporal expressions are identified. At S208, named entities are identified by the named entity extractor and labeled. At S210, the main predicate in the sentence is identified and labeled. At S212, text elements that are arguments of the main predicate are identified and labeled. The output of S106 is a set of annotated sentences in which the arguments of the main predicate are identified.

An argument, as used herein, is a text element (comprising one or more words) that is in an identified syntactic or semantic dependency relationship with the main predicate. Examples of arguments include noun phrases and prepositional phrases.

The types of syntactic/semantic dependency relationships identified may depend on the specific parser employed and the rules that it applies. As will be appreciated, the parser rules which perform the steps illustrated in FIG. 4 need not be implemented in the order illustrated and that additional steps may be performed during the parsing.

Generally each predicate includes at least a verb. The system may focus only on the main predicates and their respective arguments:

For example, in the sentence:

I will be seeing John Smith next week, who is on vacation.

The parser identifies will be seeing as the main predicate and is as a subordinate predicate. The arguments associated with the main predicate are I, John Smith, and next week. Each of these three arguments is in a dependency relationship with the main predicate: I, being in a subject relationship, and John Smith, and next week being in a modifier relationship. John Smith may also be tagged as a named entity of type PERSON and next week as a temporal expression. The subordinate predicate (is) and its arguments may be ignored.

In some embodiments, the parser 18 comprises an incremental parser, such as the Xerox Incremental parser (XIP) as described, for example, in U.S. Pat. No. 7,058,567 by Aït-Mokhtar, et al.; Aït-Mokhtar, et al., “Incremental Finite-State Parsing,” Proceedings of Applied Natural Language Processing, Washington, April 1997; and Aït-Mokhtar, et al., “Subject and Object Dependency Extraction Using Finite-State Transducers,” Proceedings ACL'97 Workshop on Information Extraction and the Building of Lexical Semantic Resources for NLP Applications, Madrid, July 1997, the disclosures of which are incorporated herein by reference. Further details on deep syntactic parsing which may be applied herein are provided in U.S. Pub. No. 20070179776, by Segond, et al., U.S. Pub. No. 20090204596, by Brun, et al., and in Ait-Mokhtar, et al., “Robustness beyond Shallowness: Incremental Dependency Parsing,” Special issue of NLE journal (2002), the disclosures of which are incorporated herein by reference.

The labels applied by the parser may be in the form of tags, e.g., XML tags, metadata, log files, or the like.

Named Entity Extraction:

As used herein, a “named entity” (NE) generally comprises a text element which identifies an entity by name and which belongs to a given semantic type. For example, named entities may include persons, organizations (such as a corporation, institution, association, government or private organization, or the like), locations (such as a country, state, town, geographic region, or the like), artifacts, specific dates, and monetary expressions, and/or other proper names which are typically capitalized in use to distinguish the named entity from an ordinary noun.

Together with the syntactico-semantic analysis described above, Named Entity Recognition (NER) is performed. This step semantically types proper nouns that are mentioned in the text. Any suitable system for extracting named entities can be used for this purpose. Classical named entity recognition systems usually associate a predefined semantic type to the entity, such as PERSON, LOCATION, ORGANIZATION, DATE, etc. The named entity extractor 82 may take, as input, a tokenized and optionally morphologically analyzed input text string or body of text, and output information on any named entities identified. Automated name entity recognition systems are described, for example, in U.S. Pat. No. 7,171,350, entitled METHOD FOR NAMED-ENTITY RECOGNITION AND VERIFICATION, by Lin, et al.; U.S. Pat. No. 6,975,766, entitled SYSTEM, METHOD AND PROGRAM FOR DISCRIMINATING NAMED ENTITY, by Fukushima, U.S. Pat. No. 6,311,152, U.S. Pub. No. 20080319978, published Dec. 25, 2008, entitled HYBRID SYSTEM FOR NAMED ENTITY RESOLUTION, by Caroline Brun, et al.; U.S. Pub. No. 20090204596, published Aug. 13, 2009, entitled SEMANTIC COMPATIBILITY CHECKING FOR AUTOMATIC CORRECTION AND DISCOVERY OF NAMED ENTITIES, by Caroline Brun, et al., the disclosures of which are incorporated herein by reference. NER systems which employ statistical methods for filtering identified named entities which may be used herein are described, for example, in Andrew Borthwick, John Sterling, Eugene Agichtein, Ralph Grishman, “NYU: Description of the MENE Named Entity System as Used in MUC-7.” In Proc. Seventh Message Understanding Conference (1998). Symbolic Methods which may be used are described in R. Gaizauskas, T. Wakao, K. Humphreys, H. Cunningham, Y. Wilks, “University of Sheffield: Description of the LaSIE System as Used for MUC-6” in Proc. Sixth Message Understanding Conference (MUC-6), 207-220 (1995). Caroline Brun, Caroline Hagege, “Intertwining deep syntactic processing and named entity detection,” ESTAL 2004, Alicante, Spain, Oct. 20-22 (2004), provides one example of a NER system which is combined with a robust parser. A hybrid system which distinguishes between literal and metonymic uses of named entities, may be employed, as described in above-mentioned U.S. Pub. No. 20080319978.

In some embodiments, named entity extraction may be performed as follows. First candidate named entities are identified. These are text elements in the sentence under consideration which match entries in a lexical resource for named entities, such as Wikipedia, or from a predefined set of named entities in a named entity lexicon. Grammar rules and/or statistical techniques may be applied to filter the candidate named entities. The named entity extractor 82 may assign a semantic type (context) to the each of the recognized named entities from a finite set of contexts, e.g., in the form of tags. In general, each named entity is assigned only a single context. In a few instances, where more than one context is assigned to an NE, this means that the named entity extractor 82 has not been able to unambiguously assign a single context. The contexts may be identified from the lexical resource, lexicon, and/or by application of rules. Coreference resolution may also be used to identify named entities corresponding to pronouns, where possible, based on surrounding text.

### Temporal Processing (S108)

As used herein a “reference date” or “temporal coordinate” refers to any normalized temporal expression, that is fixed in time, such as a specific date expressing a month, day and year (e.g., Mar. 6, 2007) or a more or less fine grained temporal coordinate involving time, in a standard calendar, such as the Gregorian calendar. Examples of such reference dates include “between noon and 6 pm on Jan. 12, 2007”, which could be stored as 200701121200-200701121800, or “Jan. 14-28, 2007”, which could be stored as 20070114-20070128, or “January 2007” which could be stored as 20070101-20070131, or “2007”.

The temporal processing component 20 normalizes temporal expressions that do not themselves identify a date, but are referential dates, i.e., for which a reference date can be identified, based on surrounding context for the temporal expression, and the temporal expression can be normalized with respect to the reference date by application of temporal expression normalization rules. In general, the surrounding context identifies a specific date which can be used as a reference date for the temporal expression. For example, in the case of news articles, the article may include a publication date or document creation date which provides the reference date for normalizing temporal expressions such as next Tuesday, last December, and this week. A set of rules are provided for normalizing temporal expressions relative to their surrounding context. For example, next Tuesday may be normalized with a rule which provides:
Replace next A with date B of format YYYY/MM/DD, where A is selected from {MONDAY, TUESDAY, . . . } and B is date of next A after reference date C

Methods for temporal processing are described, for example, in U.S. Pub. No. 20130073662, published Mar. 21, 2013, entitled SYSTEM AND METHOD FOR UPDATING AN ELECTRONIC CALENDAR, by Jean-Luc Meunier, et al.; U.S. Pub. No. 20100318398, published Dec. 16, 2010, entitled NATURAL LANGUAGE INTERFACE FOR COLLABORATIVE EVENT SCHEDULING, by Brun, et al.; U.S. Pub. No. 20090235280, published Sep. 17, 2009, entitled EVENT EXTRACTION SYSTEM FOR ELECTRONIC MESSAGES, by Tannier; Uzzaman N., Allen J., “Event and temporal expression extraction from raw text: first step towards a temporally aware system,” Intern'l J. Semantic Computing (2011), and Kessler, et al., “Finding Salient Dates for Building Thematic Timelines,” Proc. ACL 2012 (“Kessler 2012”). the disclosures of which are incorporated herein by reference, in their entireties.

In one embodiment, the temporal processing includes identifying temporal expressions in the text and tagging them. This may be performed by identifying anchor words, such as minute(s), hour(s), day(s), week(s), month(s), today, tomorrow, yesterday, Monday, o'clock, quarter, year, and the like, and the associated words which modify them. The identified temporal expressions are then classified. In this step, the identified temporal expression is assigned to one of a predefined set of temporal expression classes. Each of the different classes of temporal expression is associated with one or more rules for normalizing expressions of that class. A reference date is identified, such as the document's publication date. The appropriate class-based rules are then applied to the temporal expression to normalize it with respect to the reference date. For example, temporal expressions such as tomorrow and yesterday are readily normalized by adding or subtracting a calendar day from the reference date. Normalizing temporal expressions such as next week entail identifying start and end days of the following week.

Exemplary temporal processing systems useful herein are able to attach temporal expressions automatically to the predicate they are modifying and also are able to perform a temporal normalization for temporal expressions that are relative to the document creation time, and also sometimes, to other events present in texts.

In one embodiment, the linguistic parser 18 and the temporal processing component 20 are integrated into a common natural language processing component. An example of such a natural language processor is described, for example, in Caroline Hagège, Xavier Tannier, “XTM: A robust temporal processor,” CICLing Conference on Intelligent Text Processing and Computational Linguistics, Haifa, Israel, Feb. 17-23, 2008 (“Hagege and Tannier ‘08’).

As an example, consider the following excerpt of a document:

News article 1 (Mar. 8, 2007)

An earthquake struck the Indonesia island of Sumatra last Tuesday

The output of the linguistic and temporal processing may be as follows:

An earthquake struck the
<LOCATION>Indonesia</LOCATION> island of
<LOCATION>Sumatra</LOCATION> <TIMEX
value=”20070306”>last Tuesday</TIMEX>

And a set of dependencies, which may include the following

MAIN PREDICATE(strike)
SUBJECT(strike,earthquake)
LOCATION_MODIFIER(strike,Sumatra)
TEMPORAL_MODIFIER(strike,last Monday)

In this example, linguistic and temporal analysis extracts Indonesia and Sumatra as named entities of type LOCATION. The main verb is identified as strike and its subject (one of its arguments) is earthquake. The analysis also identifies that last Tuesday modifies the main predicate strike and thus is a second of its arguments, and that the normalized value (“TIMEX”) of this temporal expression is 20070306 (Mar. 3, 2007). Indonesia, Sumatra, and/or Indonesian Island of Sumatra is/are also identified as an argument of the main predicate strike.

As a result, an event 40 can be generated corresponding to the “strike of the earthquake in Sumatra,” which is anchored to the temporal coordinate 20070306. The analysis of News article 2 above will produce a very similar analysis but the temporal coordinate will not be the same.

### Filtering (S110)

The filtering component identifies a collection of text excerpts that satisfy the query (“events”), based on the linguistic processing and temporal processing. Specifically, it identifies only those text excerpts (such as sentences or parts of sentences), that include the query topic (or a part of it) as an argument of a predicate (e.g., a main predicate) and where there is a normalized temporal expression that is an argument of the same predicate and which corresponds to the query date range. The filtering component filters out all other text excerpts from further consideration. Duplicate (identical) text excerpts may also be omitted from the collection.

For example, if the topic is Sumatra and the query date range is March 2007, the filtering component identifies the excerpt above from News article 1 as an event that matches the query and excludes News Article 2.

As will be appreciated filtering may proceed in several stages and need not all be performed in a single step. For example, at an earlier stage, sentences which do not include at least a part of the selected topic may be filtered out. However, performing filtering after the linguistic and temporal processing stage allows the linguistic and temporal processing to be performed offline, prior to receiving the query, thus reducing the time taken to respond to the query, and allows the same set of annotated documents to be used for multiple queries.

The output of this step is a collection 32 of events 42, 44 which are responsive to the query, but which are not organized in any way. Each event includes an annotated text excerpt that includes a predicate, such as a main predicate, and respective arguments of that predicate.

### Textual Entailment (S112)

The entailment step identifies related events in the collection of text excerpts 32 identified at S110 (or a subset of them depending on the application needs). This allows the collection 32 of events to be partitioned into a plurality of sets 34, 36, etc. of events at S114.

In the textual entailment step, pairs of events 42, 44 are compared and the textual entailment component 30 detects if one of the pair of events entails the other. For each pair of events that is determined to be in an entailment relationship, therefore, one of the events is identified as the entailing event and the other as the entailed event (i.e., which can be inferred from the entailing event). In the exemplary embodiment, the entire sentence in which the text except has been found may be considered when looking for entailment relationships. However, it is also contemplated that a shorter string containing the text excerpt may be considered, which is less than the entire sentence.

In the exemplary embodiment, the normalized dates (temporal coordinates) are not considered for purposes of determining whether there is entailment between a pair of events. Temporal coordinates that have been attached to the predicates of the respective events may, however, be taken into consideration as a filter. For example, a rule may specify that events that have non-compatible temporal coordinates cannot entail one another. What is compatible may be determined by the system or by the user, for example, events with temporal coordinates which are within an hour, day, or a week, or a year may be considered compatible. Accordingly, in each set of events, all the events in the set have a date which is within a smaller date range than the date range for the query. In the exemplary embodiment, each text excerpt may be compared with every other text excerpt in the collection of text excerpts, or at least with a subset of the collection which is considered compatible based on the temporal coordinates of the extracts.

For compatible temporal coordinates, a suitable entailment detection procedure is performed. At the end of the processing, at least one set of related events is obtained where the events are linked to one another through entailment relations. In general, at least two sets of linked events, such as three, four or up to 10 or more sets are generated.

Textual Entailment (TE) is a framework for textual inference which has been applied to a variety of natural language processing (NLP) applications, by reducing the inference needs of these applications to a common task: can the meaning of one text (denoted H) be inferred from another (denoted T). When such a relation holds, then it is stated that T textually entails H. (See, Dagan, et al., “Recognizing textual entailment: Rationale, evaluation and approaches,” Natural Language Engineering, 15(4):1-17 (2009)) Paraphrases, therefore, are a special case of the entailment relation, where the two texts both entail each other. The notions of simplification and of generalization can also be captured within TE, where the meaning of the simplified or the generalized text is entailed by the meaning of the original text (see, Mirkin, S., PhD thesis, “Context and Discourse in Textual Entailment Inference,” Bar-Ilan University (2011). In the present case, TE can be used to recognize both paraphrases (which preserve the meaning) and simplification or generalization operations (which preserve the core meaning, but may lose some information) with entailment-based methods.

The exemplary textual entailment rules thus loosen the strict definition of textual entailment of formal semantics, where an entailment relation is defined as the following:

A entails B if:

Whenever A is true, B is true

The information that B conveys is contained in the information that A conveys
A situation describable by A must also be a situation describable by B A and not B is contradictory (can't be true in any situation).

See, Chierchia, G., McConnell-Ginet, S.: Meaning and grammar: An introduction to semantics, 2nd. edition. Cambridge, Mass.: MIT Press (2001).

In the exemplary embodiment, the textual entailment rules implement a more flexible definition of the entailment relation that allows entailment relations which permit uncertainty. Under the more flexible definition, Textual Entailment is defined as a directional relationship between pairs of text expressions, denoted by T—the entailing “Text”, and H—the entailed “Hypothesis” in which T entails H if, typically, a human reading T would infer that H is most likely true (see, Dagan, I., Glickman, O., Magnini, B., “The PASCAL Recognising Textual Entailment Challenge,” Lecture Notes in Computer Science, 3944, pp. 177-190, Springer-Verlag, 2006).

For recognition of entailment, the textual entailment component 30 may employ a large set of entailment rules, including lexical rules that correspond to synonymy (e.g. buy→acquire) and hypernymy (is-a relations like ‘poodle→dog’), lexical syntactic rules that capture relations between pairs of predicate-argument tuples, and syntactic rules that operate on syntactic constructs.

For example, the rules which implement a flexible entailment approach may include some or all of the following:

Rules which allow an uncertainty to be considered equivalent to an absolute value, e.g.,
Z is about (or approximately, perhaps, may be) X entails: Z is X, or Z is X±Y, or Z is X±Y % of X.

Under this rule, John is about 30 could entail each of the following strings: John is 30 and John is 29.

Rules which consider synonyms to be equivalent, e.g.,

Named Entity X entails Title or Role of Named entity

Similarly, common nouns, verbs and other parts of speech may be considered equivalent to respective stored synonyms.

Under this rule, Lincoln was shot could entail each of the following strings: The President was shot, The President was wounded.

Coreference resolution may also be used to analyze surrounding text in the same or sentence or document to identify persons corresponding to pronouns. Under this rule, John is about 30, may entail He is under 40, for example, if the previous sentence refers to John as the subject.

As will be appreciated, contextual and other requirements may also be applied to limit the equivalents which are permitted for an entailment to be found.

Any suitable textual entailment system can be used as the exemplary entailment component 30 to address the news event detection task.

Existing textual entailment systems which may be useful herein singly or in combination include multiple semantic processing components, such as one or more of lexical matching, syntactic matching, referent matching, and semantic matching (see, Cabrio et al., “Combining specialized entailment engines for RTE-4,” Proc. TAC-2008).

Lexical matching aims to identify single words or expressions which have the same meaning. An external resource may be used to measure lexical similarities between tokens from the Abstract text string and a candidate entailed text string from the main body. One such lexical resource is WordNet™ For example, a similarity score based on the WordNet Path between two tokens may be determined (see, for example, Hirst, et al., “Lexical chains as representations of context for the detection and correction of malapropisms,” in Fellbaum 1998, pp. 305-332). Another kind of similarity measure which can be used in evaluating textual entailment is the lexical entailment probability. This probability is estimated by taking the page counts returned from a search engine for a combined u and v search term, and dividing it by the count for just the v term. (See, for example, Glickman et al., “Web based probabilistic textual entailment,” in Quinonero-Candela, et al., eds, MLCW 2005, LNAI, Volume 3944, pp. 287-298, Springer-Verlag, 2006).

Syntactic matching may be found when two text elements occurring in both of the pair of text excerpts serve the same roles in a syntactic dependency e.g., are both arguments of a respective predicate (e.g., A bought B entails B was acquired by A). Syntactic matching is described, for example, in Adams, et al., “Textual Entailment Through Extended Lexical Overlap and Lexico-Semantic Matching,” Proc. ACL-PASCAL Workshop on Textual and Entailment and Paraphrasing, pp. 119-124, 2007; and Hickl, et al., “Recognizing Textual Entailment with LCC's Groundhog System,” Proc. 2nd PASCAL Challenges Workshop, 2006, “Hickl, et al. '06”). For referent matching, which uses coreference matching to identify two expressions which refer to the same entity but using different terms, see, Hickl, et al. '06 and U.S. Pub. No. 20090204596. Semantic matching involves operations such as recognizing negation and antonyms in a sentence and is described, for example, in Cabrio et al., “Combining specialized entailment engines for RTE-4,” Proc. TAC-2008.

See, for example, U.S. Pub. No. 20110276322, published Nov. 10, 2011, entitled TEXTUAL ENTAILMENT METHOD FOR LINKING TEXT OF AN ABSTRACT TO TEXT IN THE MAIN BODY OF A DOCUMENT, by Agnes Sandor and Guillaume Jacquet, the disclosure of which is incorporated herein in its entirety by reference, for a detailed description of these and other kinds of matching which may be used by the textual entailment component in identifying pairs of text excerpts that are in an entailment relationship.

An example of an existing TE system suited to use herein is the open source Bar Ilan University Textual Entailment Engine (BIUTEE), described in Stern and Dagan, “A Confidence Model for Syntactically-Motivated Entailment Proofs,” Proc. RANLP 2011, pp. 455-462, and Stern and Dagan, “BIUTEE: A modular open-source system for recognizing textual entailment,” Proc. ACL 2012 System Demonstrations, pp. 73-78, ACL 2012 (available at www.cs.biu.ac.il/^{˜}nlp/downloads/biutee).

As an example, the sentence:
Authorities in Haiti called Tuesday for evacuations as Tropical Storm Emily threatened a direct hit on the impoverished nation still struggling to recover from a devastating 2010 earthquake may be found to entail the more general:
A 2010 earthquake hit Haiti.

### Generating Sets of Events (S114)

In the exemplary embodiment, sets of events are generated based on the entailment relations identified between pairs of events. Each event 40, 42 is linked by at least one entailment relationship 46 to at least one other event in the set and in the case of sets which include more than two events, at least one of the events is linked to two other events by respective entailment relationships. In this way, all events in a given set are linked together through entailment relationships. In the form of a directed graph. See, for example, the relationships indicated by arrows 46 in FIG. 1, which are intended to be exemplary only. Each event is present in at most one of the sets. The events in each set may be labeled or indexed based on the set to which they belong. A main event 44 may be identified from the events in the set to describe the events in the set. The main event may be the text excerpt which does not entail any of the other excerpts in the set, e.g., is a most entailed one of the excerpts (e.g., the longest entailment chain). Occasionally, there may be more than one main event 44, in which case, a suitable rule may be implemented to select one of the main events as representative, for example, by drawing one at random, or applying other rules.

### Filtering Events (S116)

In one embodiment, the sets may be filtered to remove those that contain less than a threshold quantity (e.g., number or proportion) of events, and/or based on some other filtering criterion, such as to limit the number of sets to up to a maximum and/or at least a minimum number.

The set of events, after optional filtering may be output and represented in the representation 66, by the text excerpt corresponding to the main event 44 (S118). For each set of events, the documents from which the excerpts are generated may be linked to the respective main event. For example documents are automatically linked with hyperlinks, so that a reviewer can review documents relating to a respective subtopic of the query topic by clicking on the main event.

### Chronology Generation

As a further processing step, a chronology 66 of major events can be generated by ordering the main events 44 in a chronological order (S120). The chronological order can based on any suitable date information such as the corresponding normalized date and/or the reference date(s) of the main event and/or other events in each set. The automatically generated chronology can assist in improving and optimizing the manual creation of event chronologies by journalists. A journalist can review the chronology output by the system and either use it as a basis for a chronology, after validating the major events, or compare it to an existing manually created chronology, to identify major events that the journalist may have missed. The journalist may reword the sentences that the system has selected for the chronology. For each set of events, the documents from which the excerpts are generated may be linked to the respective main event in the chronology. For example documents are automatically linked with hyperlinks, so that a reviewer can review documents relating to a respective subtopic of the query topic by clicking on the main event.

The method illustrated in FIGS. 3 and/or 4 may be implemented in a computer program product that may be executed on a computer. The computer program product may comprise a non-transitory computer-readable recording medium on which a control program is recorded (stored), such as a disk, hard drive, or the like. Common forms of non-transitory computer-readable media include, for example, floppy disks, flexible disks, hard disks, magnetic tape, or any other magnetic storage medium, CD-ROM, DVD, or any other optical medium, a RAM, a PROM, an EPROM, a FLASH-EPROM, or other memory chip or cartridge, or any other tangible medium from which a computer can read and use.

Alternatively, the method may be implemented in transitory media, such as a transmittable carrier wave in which the control program is embodied as a data signal using transmission media, such as acoustic or light waves, such as those generated during radio wave and infrared data communications, and the like.

The exemplary method may be implemented on one or more general purpose computers, special purpose computer(s), a programmed microprocessor or microcontroller and peripheral integrated circuit elements, an ASIC or other integrated circuit, a digital signal processor, a hardwired electronic or logic circuit such as a discrete element circuit, a programmable logic device such as a PLD, PLA, FPGA, Graphical card CPU (GPU), or PAL, or the like. In general, any device, capable of implementing a finite state machine that is in turn capable of implementing the flowchart shown in FIGS. 3 and/or 4, can be used to implement the event extraction method. As will be appreciated, while the steps of the method may all be computer implemented, in some embodiments one or more of the steps may be at least partially performed manually.

Without intending to limit the scope of the exemplary embodiment, the following examples demonstrate the feasibility of the method.

### EXAMPLES

Experiments were conducted in order to verify the feasibility and usefulness of the method. For this proof of concept, the aim was to extract chronologies of events from a large collection of news articles. For news aggregators, such a process is advantageous but is not an easy task in the sense that defining what are the most important events during a period of time is generally a subjective task.

### Example 1

This first experiment aims at evaluating whether a textual entailment-based system is relevant for event detection from a large collection of news articles based on a specific query including keywords and a temporal expression. In this experiment, the large collection of news articles is the AFP (Agence France-Presse) corpus (600,000 news articles produced between 2010 and 2012).

The system was tested on a query which could be described as: “all the events that occurred in Haiti during the year 2010.”

A parser based on that described in Salah Aït-Mokhtar, et al., “Robustness beyond shallowness: incremental dependency parsing,” Special Issue of the NLE Journal, 2002. The parser was augmented with a temporal processing and normalization module (see Kessler 2012). Based on the linguistic and temporal processing, 11 million predicates, 340,000 temporal expressions, and 5 million Named Entities were extracted from this corpus.

Given the output of this parser (components 18 and 20 of the illustrated system), the initial query could be described by “all the text excerpts containing a predicate where the named entity “Haiti” is an argument of this predicate and the predicate is related to a temporal expression which has the normalized year 2010.”

The result of processing with the exemplary system including temporal normalization and textual entailment was the extraction of 921 text excerpts. By comparison, a much larger number of text excerpts is generated when no temporal processing is performed, given the same corpus. Extracting all text excerpts where “Haiti” is argument of a predicate, without any temporal constraints, generates 38,536 text excerpts. On the other hand, if all text excerpts where Haiti is argument of a predicate and with the string pattern “2010” in the temporal expression attached to this predicate, only 10 text excerpts are extracted.

Some examples of text excerpts extracted by the three described configurations are as follows:

A. Only “Haiti” as argument of a predicate (without temporal expression): 38,536 text excerpts. Query results:
1. Dominican president Leonel Fernandez, hosting the conference, stressed that Haiti is not alone, and never will be.
2. Health officials in the Dominican Republic have introduced new measures to try to slow the advance of the disease from Haiti.
   B. Text excerpts where Haiti is argument of a predicate and with the string pattern “2010” in the temporal expression attached to this predicate (without Normalized Temporal Expression): 10 text excerpts. Example Query Results:
1. Torrential rains lashed Haiti on Tuesday, flooding shanty towns and squalid camps erected after a 2010 earthquake and killing at least 10 people, officials said.
2. Authorities in Haiti called Tuesday for evacuations as Tropical Storm Emily threatened a direct hit on the impoverished nation still struggling to recover from a devastating 2010 earthquake.
C. Text excerpts where “Haiti” is an argument of a predicate and this predicate is related to a date which has the normalized year 2010 (Exemplary method)
1. US lawmakers are urging Secretary of State Hilary Clinton to make it clear that Washington will withhold funds for elections in Haiti next month if they are not going to be free, fair, and inclusive.
2. An international conference on aid to quake-stricken Haiti is due to take place Wednesday in the neighboring Dominican Republic.

Based on the set of text excerpts extracted from this last query, an evaluation of the entailment relations identified by the textual entailment component described above (BIUTEE tool). From the initial 921 text excerpts, 345 text excerpts were excluded as duplicates, i.e., being exactly the same as a remaining excerpt. In order to speed up the evaluation, 100 text excerpts were randomly extracted from the remaining 576 unique text excerpts. The BIUTEE tool was used in order to decide for each pair (t1,t2) of text excerpts, if t1 entails t2. This meant 9900 (100×99) pairs to be compared. As a ground truth, a manual annotation of the entailed text excerpt pairs from those 9900 text excerpt pairs was provided. Based on these manual annotations, 54 pairs were identified as an entailment between text excerpts. The BIUTEE tool identified 35 entailed pairs. The quality of these identified pairs was indicated by a Precision of 0.942, a Recall of 0.6, and an F-score of 0.733.

These results, although on a limited scale, suggest that this TE tool gives relevant results with a very good precision and an acceptable recall which fit with the requirements.

To determine whether the results are comparable to what a human may consider as the major events which happened during 2010 in Haiti, as a ground truth the Haiti Wikipedia article describing happenings in 2010-2011. The output of the TE component is a set of directed relations between text excerpts. A directed graph is generated where each vertex is a text excerpt or “event” and each arrow is an entailment relation. In this graph, each set of connected events is considered as a major event. The number of events in a set is considered to be correlated to the importance of the corresponding major event.

The five most important sets of events (sets with at least three vertices) were identified. Each set is described by its most entailed text excerpt (main event 44), as follows:
1. Just last week, Clinton paid his second visit to Haiti in a bid to get aid moving to the impoverished Caribbean nation struck by a 7.0-magnitude quake on January 12, and apologized for the slow arrival of relief supplies
2. An international conference on aid to quake-stricken Haiti is due to take place Wednesday in the neighbouring Dominican Republic.
3. UN braces for significant increase in Haiti cholera cases
4. Unlike impoverished Haiti, which was also struck by a devastating earthquake last month, Chile is one of Latin America's wealthiest countries.
5. Haiti's presidential and legislative elections, delayed by the massive January earthquake that killed up to 300,000 people, have been set for November 28

By comparison, the Wikipedia section on Haiti for 2010-2011 references a) the 2010 Haiti earthquake b) a cholera epidemic on Oct. 14, 2010, c) Hurricane Thomas, d) general elections planned for January 2010, which were postponed due to the earthquake.

Based on this comparison, it can be concluded that of the five automatically extracted event sets, only one (no. 4) is not relevant for the topic “main events in Haiti in 2010”, even though Haiti's earthquake is mentioned in this excerpt. Sets 1 and 2 contain information that could usefully have been added to the Wikipedia section. The absence of an event set for Hurricane Tomas may be explained by the fact that this preliminary evaluation was done with only 100 randomly extracted text excerpts from the 576 text excerpts extracted by the system.

### Example 2

Currently, journalists may browse, based on simple keywords, millions of news articles from large news archives and extract events they consider relevant enough for a specific chronology (chronology example: “all the main events in Haiti during 2010”). The present system may create such a chronology automatically, or provide a draft. Given a query from the journalist, a draft of a chronology may be automatically generated by the system. The journalist can clean it up or add further information in order to create a deliverable chronology. In this example, a chronology of major events created by the exemplary system was compared with a chronology with a ground truth which is a list of chronologies manually created by experts (in this case, journalists).

From the ground truth, for each chronology, the following information is obtained:

a) The initial query used by the journalist in order to find news articles related to the chronology (s) he has to create.

b) The starting and ending dates of the chronology.

c) The chronology itself represented by a set of daily dates and for each date, all the main events that happened during that day.

In this experiment, the initial query and the starting and ending dates were used as an input for the exemplary system and the manual chronology as the reference to evaluate the “draft chronology”. Measuring the distance between two chronologies is not an easy task since the comparison between two events should be based on the meaning of each excerpt and not only based on the shared excerpt words. A set of qualitative comparisons between the automatic draft chronologies and the manually created chronologies was therefore used as a guide.

TABLE 1 shows the results of a manual evaluation on three automatically created chronologies when compared with the corresponding chronologies generated by journalists. The headlines below are the titles created by the journalists for the respective chronology and the initial query (topic and start and end dates) used by the system was the same as used by the journalist:

### Chronology 1

Headline: “The US parcel bomb plot as it unfolded”

Initial query: “parcel bomb attacks britain yemen”

Starting and ending date: 2010 Oct. 29-2010 Oct. 30

### Chronology 2

Headline: “Pakistan under water—a timeline”

Initial query: “water pakistan weather floods”

Starting and ending date: 2010 Jul. 29-2010 Aug. 6

### Chronology 3

Headline: “Timeline of Icelandic volcano crisis”

Initial query: “icelandic volcano”

Starting and ending date: 2010 Apr. 14-2010 May 4

The following measures were considered:

$$\% Recall ( R ) = \frac{Correct events}{Ground Truth events} \times 100$$

$$\% Precision ( P ) = \frac{Correct events + duplicate events}{Total automatic events} \times 100$$

where

Correct Events=an event is “Correct” if an event with the same meaning (or a very close meaning) is found in the Ground Truth.

Ground Truth Events, GT=The events identified by the journalist for that chronology.

New Events=An event is “New” if its meaning is not part of any event from the Ground Truth, but it could have been included.

Duplicate events=An event is counted as a “Duplicate” if a previous event with the same meaning has been annotated as “Correct”.

Total automatic events=total of system identified events in the respective column over all three chronologies.

Nb.=Number of excerpts from query.

An event is considered “Wrong” if it is not relevant for the chronology.

TABLE 1

| | Events Identified by the system | | | | | | | | | |
|---|---|---|---|---|---|---|---|---|---|---|
| Chron. | Correct | Duplicate | New | Wrong | Total | Nb | GT | P | SP | R |
| 1 | 7 | 4 | 2 | 3 | 16 | 71 | 12 | 68.8 | 81.3 | 58.3 |
| 2 | 10 | 16 | 2 | 4 | 32 | 152 | 11 | 81.3 | 87.5 | 90.1 |
| 3 | 10 | 34 | 2 | 0 | 46 | 479 | 13 | 95.7 | 100 | 76.9 |
| Total | 27 | 54 | 6 | 7 | 94 | 702 | 36 | 86.2 | 92.6 | 75.0 |

As an example of a new event, in Chronology 1, an event was extracted about “Yemeni prosecutors accused Awlaqi on Tuesday of having links to Al-Qaeda and of incitement to kill foreigners, following the discovery of two parcel bombs on US-bound flights last Friday.” A journalist may consider this event as relevant for the chronology even if it was not part of the ground truth. It is then part of the “new” events.

The table shows that only 7.4% of the extracted events are “wrong” by these measures. The amount of duplication is significant but it can be put into perspective by considering the initial amount of excerpts to be analyzed by the journalist. From the three chronologies, the number of excerpts from the corresponding queries is 702 and 94 major events were extracted from them.

The soft precision aims at showing how the precision could be affected if the “New” event is included in the correct events. With a resulting precision of 86.2% and a recall of 75%, this suggests that the system is close enough to the ground truth to be useful for the chronology creation.

It will be appreciated that variants of the above-disclosed and other features and functions, or alternatives thereof, may be combined into many other different systems or applications. Various presently unforeseen or unanticipated alternatives, modifications, variations or improvements therein may be subsequently made by those skilled in the art which are also intended to be encompassed by the following claims.

What is claimed is:

1. A method for extraction of events comprising:
performing linguistic processing on a collection of text documents to identify predicates and respective arguments of the predicates;
performing temporal processing on the collection of documents to normalize referential dates;
receiving a query which includes a topic and date information which defines a date range;
identifying a collection of excerpts from the collection of documents, each excerpt including an argument which is based on the topic and a normalized reference to a date which matches the defined date range;
identifying a plurality of sets of events in the collection of excerpts, each set of events comprising a plurality of the excerpts in the collection that are linked together by entailment relationships; and
wherein at least one of the performing linguistic processing, performing temporal processing, identifying a collection of excerpts, and performing textual entailment is performed with a computer processor.

2. The method of claim 1, wherein the performing linguistic processing comprises identifying a main predicate and respective arguments for each of a collection of sentences in the collection of text documents.

3. The method of claim 1, wherein the excerpts in the collection of excerpts each include an argument which is based on the topic as a first argument of a respective predicate and a normalized reference to a date which matches the defined date range as a second argument of the predicate.

4. The method of claim 1, wherein the performing temporal processing on the collection of documents includes identifying temporal expressions in the documents and normalizing each temporal expression with respect to a reference date of a respective document in which the temporal expression is identified.

5. The method of claim 1, wherein the linguistic processing comprises identifying named entities and wherein when the query includes a named entity in the topic, the identifying of the collection of excerpts includes identifying excerpts that each include a predicate which has a first argument which is based on the named entity in the topic and a second argument which includes a normalized reference to a date which matches the defined date range.

6. The method of claim 1, wherein the documents comprise news articles.

7. The method of claim 1, wherein the identifying a plurality of sets of events in the collection of excerpts comprises applying a set of textual entailment rules for identifying pairs of entailing and entailed excerpts.

8. The method of claim 1, wherein the identifying a plurality of sets comprises applying rules for detection of textual entailment between a pair of excerpts, the rules selected from the group consisting of lexical rules that identify synonymy between arguments of an entailing excerpt and an entailed excerpt, lexical rules that identify hypernymy between arguments of an entailing excerpt and an entailed excerpt, lexico-syntactic rules that capture relations between a pair of predicate-argument tuples of an entailing excerpt and an entailed excerpt.

9. The method of claim 1, wherein the identifying a plurality of sets of events in the collection of excerpts includes identifying excerpts that are linked by entailment relationships and which each have a date which is within a smaller date range than the date range for the query.

10. The method of claim 1, wherein the identifying a plurality of sets of events in the collection of excerpts includes identifying a first set of excerpts in which every excerpt is linked to at least one other excerpt in the first set by a textual entailment relationship and identifying a second set of excerpts in which every excerpt is linked to at least one other excerpt in the second set by a textual entailment relationship.

11. The method of claim 1, further comprising filtering out sets of events which each contain fewer than a threshold quantity of excerpts.

12. The method of claim 1 further comprising, for each of the plurality of sets of events in the collection of excerpts identifying a main event from the set of excerpts as representative of the set of events.

13. The method of claim 12, wherein the main event comprises an excerpt which does not entail any of the other excerpts.

14. The method of claim 1 wherein each excerpt is no more than a single sentence.

15. The method of claim 12, further comprising generating a chronology of main events, each of the main events in the chronology being identified from a respective set of events.

16. The method of claim 1, further comprising outputting information based on the identified plurality of sets of events.

17. A computer program product comprising a non-transitory computer-readable medium storing instructions, which when executed by a processor, perform the method of claim 1.

18. A system for extraction of events comprising memory which stores instructions for performing the method of claim 1 and a processor in communication with the memory which executes the instructions.

19. A system for extraction of events comprising:
memory which stores an annotated collection of natural language text documents in which predicates and respective arguments of the predicates are identified, at least one of the arguments of each identified predicate comprising a temporal expression which is normalized with respect to a reference date of a respective document;
a filtering component which, based on an input query which includes a topic and date information which defines a date range, identifies a collection of excerpts from the annotated collection of documents, each excerpt including an argument, which is based on the topic, and a normalized reference to a date which matches the defined date range of the query;
a textual entailment component which identifies excerpts in the collection that are linked together by entailment relationships;
an event set identification component which identifies a plurality of sets of events in the collection of excerpts, each set of events comprising a plurality of the excerpts in the collection that are linked together by entailment relationships; and
a processor which implements the components.

20. The system of claim 19, further comprising a representation generator which generates a representation of the plurality of sets of events in which each set is represented by a main event that comprises an excerpt which does not entail any of the other excerpts in the set.

21. A method for generating a chronology comprising:
receiving a collection of news articles each article identifying a reference date;
receiving a query which includes a topic and date information which defines a date range;
natural language processing the articles to identify excerpts, each of the excerpts including a predicate and arguments of the predicate, a first of the arguments of the predicate matching at least part of the topic, a second of the arguments of the predicate including a temporal expression which, when normalized with respect to the reference date of the article, matches the date information of the query;
partitioning the excerpts into sets of events, each set of events including excerpts that are linked together by entailment relationships;
for each of a plurality of the sets of events, identifying a main event based on an excerpt which does not entail any of the other excerpts in the set;
forming a chronology based on the main events; and
wherein at least one of the processing of the articles, partitioning excerpts, identifying main events, and forming a chronology is performed with a computer processor.
